(19) United States
(12) Patent Application Publication
(10) Pub. No.: US 2026/0048738 A1
(43) Pub. Date: Feb. 19, 2026

(54) VEHICULAR COLLISION AVOIDANCE SYSTEM WITH REAR COLLISION MITIGATION

(71) Applicant: Magna Electronics Inc., Auburn Hills, MI (US)

(72) Inventor: Jagadish Narayan Gowda, Bengaluru (IN)

(21) Appl. No.: 19/297,409

(22) Filed: Aug. 12, 2025

Related U.S. Application Data
(60) Provisional application No. 63/683,735, filed on Aug. 16, 2024.

(51) Int. Cl. B60W 30/09; B60W 30/095; B60W 30/14; B60W 30/16; B60W 30/18; B60W 40/08; B60W 40/09; B60W 50/14

(52) U.S. Cl. CPC B60W 30/09; B60W 30/0956; B60W 30/146; B60W 30/162; B60W 30/18154; B60W 40/09; B60W 50/14; B60W 2040/0809; B60W 2040/0818; B60W 2050/143; B60W 2050/146; B60W 2420/403; B60W 2420/408; B60W 2520/10; B60W 2540/043; B60W 2540/229; B60W 2552/30; B60W 2554/4042; B60W 2554/802

(57) ABSTRACT

A vehicular driving assist system includes a sensor disposed at a vehicle. The vehicular driving assist system is operable to at least partially control the equipped vehicle as the equipped vehicle moves in a direction of travel. As the equipped vehicle moves in the direction of travel, and based on processing captured sensor data, the vehicular driving assist system determines a following vehicle at least rearward of the equipped vehicle and travelling in the direction of travel. With the determined following vehicle at least rearward of the equipped vehicle, and based on determination of a potential forward braking event relative to a road condition at least forward of the equipped vehicle, the vehicular driving assist system adjusts control of the equipped vehicle to commence reducing speed of the equipped vehicle at a distance relative to the determined road condition greater than when no following vehicle is determined.

### CROSS REFERENCE TO RELATED APPLICATION

The present application claims the filing benefits of U.S. provisional application Ser. No. 63/683,735, filed Aug. 16, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assist system includes a sensor disposed at a vehicle equipped with the driving assist system. The sensor senses a region at least rearward of the equipped vehicle and generates sensor data. An electronic control unit (ECU) includes electronic circuitry and associated software and includes a processor operable to process sensor data captured by the sensor and transferred to the ECU. The driving assist system is operable to at least partially control the equipped vehicle as the equipped vehicle moves in a direction of travel on a road. As the equipped vehicle moves in the direction of travel on the road, and based on processing captured sensor data transferred to the ECU, the driving assist system detects a following vehicle at least rearward of the equipped vehicle and travelling in the direction of travel on the road. Based on determination of a forward collision risk at least forward of the equipped vehicle in the direction of travel, and based on determination of a rearward collision risk between the equipped vehicle and the following vehicle, the driving assist system adjusts control of the equipped vehicle to reduce a speed of the equipped vehicle in the direction of travel.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle equipped with a driver assist system;

FIG. 2 is a schematic diagram of the equipped vehicle travelling along a road, with a rear approaching or following vehicle travelling along the road rearward of the equipped vehicle and with a collision situation present along the road forward of the equipped vehicle; and

FIG. 3 is a flow diagram of an example method of the driver assist system causing the equipped vehicle to slow down or stop based on determination of a risk of collision between the equipped vehicle and the following vehicle due to the collision situation and the driving parameters of the following vehicle.

### DESCRIPTION OF THE PREFERRED EMBODIMENTS

A vehicle vision system and/or driver or driving assist system and/or object detection system and/or alert system operates to capture images and/or sensor data exterior of the vehicle and may process the captured image data and sensor data to display images and to detect objects at or near the vehicle and in the predicted path of the vehicle, such as to assist a driver of the vehicle in maneuvering the vehicle in a rearward direction. The vision system includes an image processor or data processor or image processing system that is operable to receive image data from one or more cameras and provide an output to a display device for displaying images representative of the captured image data. Optionally, the vision system may provide display, such as a rearview display or a top down or bird's eye or surround view display or the like.

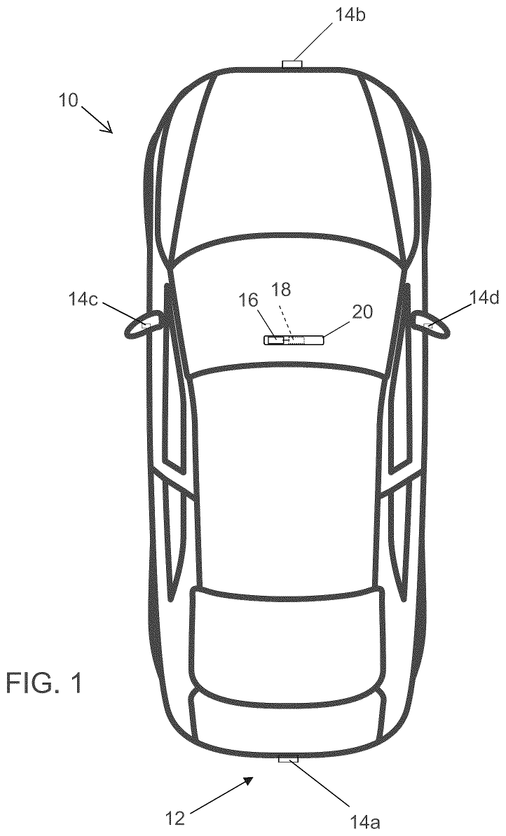

Referring now to the drawings and the illustrative embodiments depicted therein, a vehicle 10 includes a vision system or driving assist system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The driving assist system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle. Although shown and described as being equipped with a plurality of cameras, the vehicle may also be equipped with a plurality of non-imaging sensors, such as a plurality of radar sensors and/or a plurality of lidar sensors and/or a plurality of ultrasonic sensors.

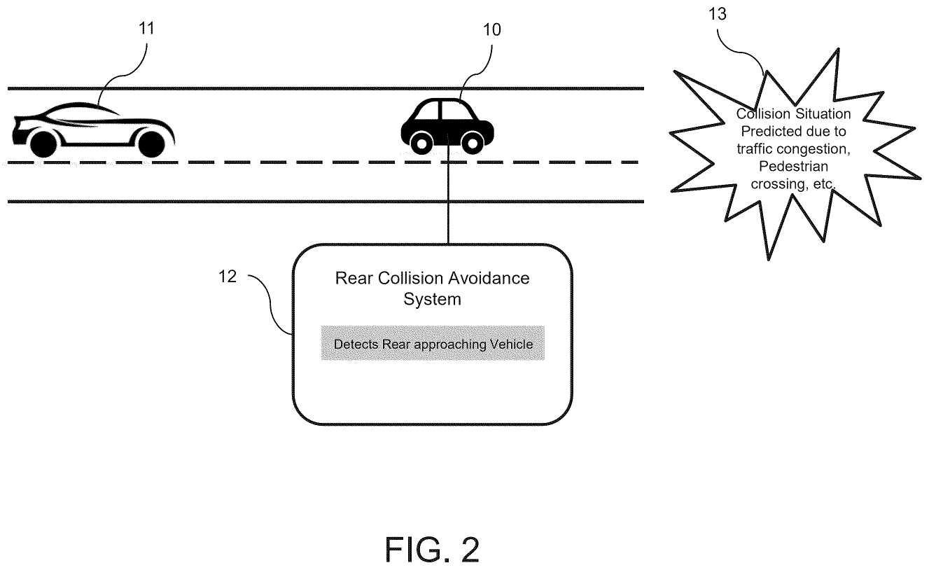

As discussed further below, the driving assist system 12 monitors other vehicles 11 rearward of the equipped vehicle 10 and moving in the same general direction of travel as the equipped vehicle 10 (FIG. 2). These other vehicles 11 may be referred to herein as following vehicles or approaching vehicles. The following vehicle 11 may be travelling in the same lane of the road on which the vehicle 10 is travelling and directly behind the equipped vehicle 10. In some examples, the following vehicle 11 may be travelling in a lane adjacent to the lane of the equipped vehicle 10 and at least partially rearward of the equipped vehicle 10, and/or the following vehicle 11 may be merging or moving into or out of the same lane or adjacent lane of the equipped vehicle 10. Based on determination of a potential forward collision of the equipped vehicle 10, and/or determination that the equipped vehicle 10 may come to a sudden stop or decelerate quickly to avoid or mitigate a potential forward collision, and based on determination or detection of the following vehicle 11, the driving assist system 12 may at least partially control operation of the vehicle 10 to reduce speed of the vehicle 10. This reduces or mitigates or avoids collision between the vehicle 10 and the forward collision risk and between the vehicle 10 and the following vehicle 11. That is, based on determination or detection of the following vehicle 11, the driving assist system 12 may react to the forward collision risk by reducing speed of the equipped vehicle 10 more gradually or at an earlier point in time than if no following vehicle 11 is detected to avoid a potential rear collision event between the equipped vehicle 10 and the following vehicle 11. The system may utilize aspects of the systems described in U.S. Pat. Nos. 11,267,393; 9,260,095; 9,174,574 and/or 9,092,986, which are hereby incorporated herein by reference in their entireties.

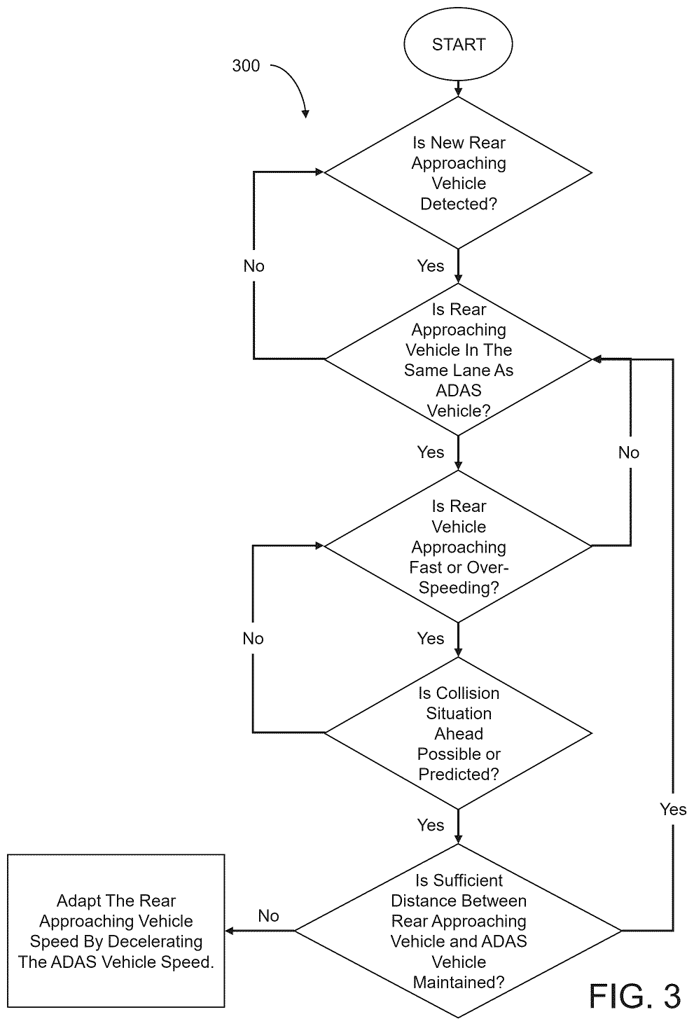

Referring to FIGS. 2 and 3, when the driving assist system or rear collision avoidance system 12 at the equipped vehicle 10 determines or detects presence of the following vehicle 11 and determines a collision situation or road condition or potential stopping or braking event 13 ahead of the equipped vehicle 10, the driving assist system 12 may adapt the speed or reduce the speed of the equipped vehicle 10 when the collision situation or potential braking event 13 is predicted and there is a probability of a rear collision due to panic or emergency braking of the equipped vehicle 10. The collision situation 13 may be predicted or determined based on determination of traffic congestion or a traffic jam, a pedestrian crossing within a predicted path of the vehicle 10, a junction in the road (e.g., an intersection having a stop sign or traffic light), less than a threshold braking distance between the equipped vehicle and a leading vehicle, a fast approaching vehicle from a sideward direction of the equipped vehicle, unexpected situations like another vehicle moving into the same lane as the equipped vehicle without using a turn signal, an animal crossing within the predicted path of the vehicle 10, presence of an object within the predicted path of the vehicle 10 and the like. Put another way, the potential braking event 13 is determined based on a road condition at least forward in the direction of travel of the equipped vehicle 10. The road condition may include a detected object or pedestrian or other vehicle in the road, and optionally in the path of travel or moving toward the path of travel of the vehicle. Optionally, the road condition includes a feature of the road that may lead to a braking or slowing or stopping event, such as an intersection (e.g., having a stop sign or traffic light), a reduced speed zone (e.g., where the speed limit of the road is reduced, such as a school zone), a curve or bend in the road, and the like.

In other words, the driving assist system 12 monitors the following vehicle 11 via processing of captured sensor data (e.g., image data and/or long-distance radar sensor data) and determines characteristics of the following vehicle 11, such as a distance between the equipped vehicle 10 and the following vehicle 11, an absolute speed of the following vehicle 11, a speed of the following vehicle 11 relative to the equipped vehicle 10, a predicted path of travel of the following vehicle 11 (e.g., an overlap path with respect to a path of travel of the equipped vehicle 10), a determination of whether the following vehicle 11 is in the same lane of travel as the equipped vehicle 10 or a lane adjacent to the equipped vehicle 10, a time to collision between the equipped vehicle 10 and the following vehicle 11, and the like. As the driving assist system 12 monitors the following vehicle 11, the system may determine whether a sudden deceleration of the equipped vehicle 10 would cause or would be likely to cause the following vehicle 11 to collide with the equipped vehicle 10, such as due to the following vehicle 11 travelling too close to the equipped vehicle 10, the following vehicle 11 travelling at a speed greater than the equipped vehicle 10, and the like. For example, based on determination of the speed of the following vehicle 11, the distance between the equipped vehicle 10 and the following vehicle 11, and a determination that the predicted path of travel of the following vehicle 11 at least partially overlaps the path of travel of the equipped vehicle 10, the driving assist system 12 may determine that the equipped vehicle 10 is at risk of collision with the following vehicle 11. The system 12 may determine a rearward collision event based on the risk of collision with the following vehicle 11 being greater than a threshold risk level.

This may be based on determination of the overlapping paths of travel, determination that the speed of the following vehicle 11 is greater than or equal to the speed of the equipped vehicle 10 (or less than the speed of the equipped vehicle 10 by less than a threshold speed difference, such as within 1 mile per hour or less, within 5 miles per hour or less, within 10 miles per hour or less, and the like), and/or determination that the following vehicle 11 is within a threshold distance of the equipped vehicle (e.g., less than 50 meters, less than 20 meters, less than 10 meters, less than 5 meters, less than 3 meters, and the like).

Based on determination of the collision situation or collision condition 13 (i.e., presence of an object or road condition or environment condition that may cause the equipped vehicle 10 to slow down or stop to a degree that could cause the following vehicle 11 to collide with the equipped vehicle 10), the driving assist system 12 may adjust the speed of the equipped vehicle 10 to reduce or eliminate chance of collision with the following vehicle 11. The collision situation 13 may be determined by the driving assist system 12 based on processing of captured sensor data and/or determination of a road condition (e.g., wet or icy or dry roads, pavement or dirt or gravel roads, and the like), determination of a road junction or intersection, determination of a traffic jam or traffic congestion, determination of an environmental condition (e.g., sunny weather or rainy weather or snowy weather, bright lighting conditions or dark lighting conditions or cloudy lighting conditions, and the like), determination of a driving condition of the equipped vehicle (e.g., travelling at high speeds or travelling over a speed limit, aggressive or rash driving behaviors, and the like), and the like.

Thus, based on determination of the collision situation 13, and based on determination that the following vehicle 11 is a collision risk for the equipped vehicle 10, the driving assist system 12 may cause the equipped vehicle to slow down or stop and/or may actuate the brake lights of the equipped vehicle to reduce the speed of the equipped vehicle and/or the following vehicle 11 and to reduce an approaching speed of the following vehicle 11 toward the equipped vehicle 10. For example, the driving assist system 12 may operate the braking system of the equipped vehicle 10 to slow down or decelerate or stop the equipped vehicle 10, or the driving assist system 12 may reduce the speed of the vehicle 10 by reducing power provided by a propulsion system of the vehicle. This may cause the equipped vehicle 10 to react to collision situations 13 earlier (e.g., at a greater distance along the road from the collision situation) when the following vehicle 11 is present than when the following vehicle is not present. Optionally, the system 12 may cause the equipped vehicle 10 to react to collision situations 13 earlier when the rearward collision risk is greater than the threshold level (e.g., due to the distance between the equipped vehicle 10 and the rearward vehicle 11 being less than the threshold distance) than when the rearward collision risk is less than the threshold level (e.g., due to the distance between the equipped vehicle 10 and the rearward vehicle 11 being greater than or equal to the threshold distance). In other words, the equipped vehicle 10 may slow down more gradually and/or over a longer distance when the collision situation 13 is detected to provide more time or distance for the following vehicle 11 to react and thus reduce risk of collision between the equipped vehicle 10 and the following vehicle 11 while maintaining or improving reaction for the equipped vehicle 10 to the collision situation 13. When the following vehicle is not present or the collision risk is less than the threshold level, the driving assist system 12 may react to collision situations 13 later (e.g., at a shorter distance along the road from the collision situation) so that the speed of the vehicle 10 is reduced closer to the collision situation 13 and to prevent the driving assist system 12 from being overly sensitive.

Optionally, the driving assist system 12 may generate a signal viewable by the following vehicle 11 (e.g., a driver of the following vehicle or a sensor system of the following vehicle) that indicates that the following vehicle 11 is a collision risk for the equipped vehicle 10. For example, based on determining that the following vehicle 11 is too close to the equipped vehicle 10 and thus would be likely to collide with the equipped vehicle 10 should the equipped vehicle 10 suddenly slow down or stop, the driving assist system 12 may illuminate a rear facing light module (e.g., a brake light or a light module separate from the braking system). The rear facing light module, when operated, may display an icon or message (e.g., a symbol representative of a stop sign) or emit colored light (e.g., amber light or red light) to signal the following vehicle 11. The driving assist system 12 may continuously or periodically illuminate the rear facing light module until the risk of collision with the following vehicle 11 is sufficiently reduced (e.g., the following vehicle reduces its speed and/or a distance to the following vehicle increases). In some examples, the driving assist system 12 may generate the signal viewable by the following vehicle based on determination that the following vehicle is a collision risk for the equipped vehicle and based on determination of the forward collision situation 13. This may cause the following vehicle 11 to reduce the collision risk between the equipped vehicle 10 and following vehicle 11 without activating the braking system or otherwise slowing the equipped vehicle 10.

That is, the driving assist system 12 avoids hazardous events due to rear collisions when the equipped vehicle 10 applies emergency braking. One of the major reasons for rear collisions is due to the driver of the vehicle 10 suddenly braking or decelerating due to untoward or unpredicted collision events. The driving assist system 12 provides greater driver safety by controlling the equipped vehicle speed and thereby causing the rear approaching vehicle 11 to adapt to the situation. The system 12 provides greater vehicle safety by assessing vehicle driving with respect to other traffic and environmental conditions.

FIG. 3 depicts an example method 300 of operation of the driving assist system 12. The system 12 may detect the following vehicle 11 approaching the equipped vehicle 10. Based on determination that the following vehicle 11 is approaching in the same lane as the equipped vehicle 10, the system 12 determines whether the following vehicle 11 is approaching fast or over-speeding. That is, the system 12 may determine that the speed of the following vehicle 11 is greater than the equipped vehicle 10 by at least a threshold amount (e.g., greater by 5 miles per hour or more, greater by 10 miles per hour or more, greater by 25 miles per hour or more, and the like). Based on determination that the following vehicle 11 is approaching fast, the system 12 may determine if a collision situation 13 ahead of the equipped vehicle 11 is detected or predicted. Based on determination that the collision situation 13 is detected or predicted, the system 12 may determine if there is sufficient distance between the equipped vehicle 10 and the following vehicle 11 so that the following vehicle 11 may stop or slow down without colliding with the equipped vehicle 10 if the equipped vehicle 10 was to initiate emergency braking. Based on determination that there is not sufficient distance between the equipped vehicle 10 and the following vehicle 11, the system 12 may adapt or adjust the speed of the following vehicle 11 by decelerating the equipped vehicle 10.

Optionally, the vehicle 10 may be equipped with a driver monitoring system (DMS) and/or occupant monitoring system (OMS) for monitoring the interior cabin of the vehicle 10, such as to determine gaze direction and hand placements of the driver, to determine distracted driving behaviors and drowsy driving behaviors, and the like. The driving assist system 12 may generate an alert to the driver of the vehicle 10 and/or to a user remote from the vehicle 10 (e.g., an owner of the vehicle, a manager of fleet vehicles, an insurance carrier, and the like) based on determination of a driving condition or driving behavior or driving violation such as the driver driving the vehicle 10 without buckling their seatbelt, the driver using a mobile device, the driver directing their gaze away from the road, and the like. That is, based on processing of sensor data captured by the DMS, the system 12 may determine that the driver is performing an unsafe behavior or distracted behavior and generate an alert to the driver and/or a third party associated with the vehicle 10 (e.g., an insurance company, an owner of the vehicle, a manager of a fleet vehicle like a rental company, and the like). The alert may be provided to the driver, such as by playing an audio tone or audio message within the vehicle, displaying or illuminating an alert icon or message at the vehicle dashboard (e.g., at the gauge cluster or infotainment screen), and the like. The alert may be provided to the third party remote from the vehicle 10, such as by transmitting a message to a user device (e.g., mobile phone) via a wireless network.

Optionally, the unsafe or distracted behavior may be personalized based on an identity of the driver. That is, the system 12 may store in memory a settings profile associated with one or more drivers of the vehicle 10 and the settings profile may identify one or more situations or behaviors or triggers that, when detected by the DMS while the associated driver is operating the vehicle 10, cause the system 12 generate the alert. For example, the settings profile for a first driver may indicate that the first driver is allowed to use a mobile device while operating the vehicle 10 while the settings profile for a second driver may indicate that the second driver is not allowed to use a mobile device while operating the vehicle 10. In other words, no alert will be generated when the first driver is determined to be using the mobile device while an alert will be generated when the second driver is determined to be using the mobile device. The settings profiles may be stored in memory at the vehicle 10 or retrieved from a remote server. Optionally, each settings profile may be associated with a category of driver (e.g., a young or teenage driver, an older or adult driver, a new or inexperienced driver, an experienced driver, a chauffeur or professional driver, and the like), and the system 12 may determine the settings profile for the driver based on a determined category or classification of the driver.

The settings profiles for each driver or driver category may be customized by an owner of the vehicle, such as via inputs provided at the vehicle 10 (e.g., at an infotainment system of the vehicle) or via inputs provided at a remote device (e.g., a mobile device associated with the owner of the vehicle). The system 12 may determine the identity of the current driver of the vehicle 10, such as based on image data captured by the DMS or based on presence of a mobile device or keyfob associated with the driver in the vehicle 10. Thus, based on determination of the identity of the driver, and based on determination of an unsafe driving behavior by the DMS, and based on determination that the unsafe driving behavior is prohibited by the settings profile of the identified driver, the system 12 may generate the alert to the driver and/or third party.

Optionally, based on determining a rule violation, the system 12 may store information or a report associated with the rule violation in memory (e.g., at the vehicle or the system may transmit the information to a remote server). For example, the system 12 may store an identity of the driver, a description of the rules violation, a time stamp of the rules violation, a date of the rules violation, and the like. This may be accessed by the owner of the vehicle 10, and/or transmitted to a third party like an insurance company.

In some examples, the system 12 may adjust driving parameters of the vehicle 10 based on detecting an unsafe driving behavior. For example, the system 12 may reduce speed of the vehicle 10 (or reduce a top speed of the vehicle) or other functionalities (e.g., operation of an infotainment system) based on the detected behavior and settings profile associated with the driver of the vehicle 10.

In other words, the system 12 may be integrated with or communicate with the DMS. The DMS may monitor the driver of the vehicle 10, such as to determine that the driver's hands are off the steering wheel, to determine that the driver is holding an electronic device (e.g., talking or texting on a mobile phone), to determine that the driver's seatbelt is unbuckled while the vehicle 10 is moving, and the like. For example, the DMS may detect the driver's facial/skull point to detect that the driver is holding an electronic device. A seat belt switch may detect whether the seat belt is buckled or not.

The system 12 may determine the personalized settings for the driver and generate the alert or message to notify the driver that they are violating the personalized rules. The vehicle owner may set personalization for the vehicle users or drivers, such as using a human machine interface (HMI), for any violation. For example, the vehicle owner may adjust settings for which behaviors are categorized as violations and/or which violations generate an alert to the driver or owner. In some examples, the system 12 may determine violations without generating the alert.

The notification may be provided on the vehicle dashboard and/or to the vehicle owner, such as by transmitting information over a wireless network (e.g., LTE/5G). The system 12 equipped with the ADAS may degrade the vehicle 10, such as by reducing the speed or other functionalities of the vehicle 10 in order to reduce safety hazards. The system 12 may store the violated rules with details (e.g., a time stamp and date), such as to provide to an insurance company for calculating insurance premiums or processing an insurance claim. For example, the internal memory may be read through an on-board diagnostic (OBD II) connector or diagnostic tool for determining the driving patterns.

Thus, the system 12 avoids hazardous events due to irresponsible driving behavior. The system 12 provides improved driver safety and improved awareness of vehicle usage by other drivers.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/864,663, filed Nov. 11, 2024 (Attorney Docket DON01 P4810), and/or International PCT Application No. PCT/US25/0308021, filed Jul. 17, 2025 (Attorney Docket DON01 FP5398WO) and/or International PCT Application No. PCT/US25/27206, filed May 1, 2025 (Attorney Docket DON01 FP5372WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-006427; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-006427; US-2021-0245662; US-2021-0162926; US-2021-0155167 and/or US-2019-0118717, which are all hereby incorporated herein by reference in their entireties.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a sensor disposed at a vehicle equipped with the vehicular driving assist system, wherein the sensor senses a region exterior of the equipped vehicle and at least rearward of the equipped vehicle, and wherein the sensor is operable to capture sensor data;
an electronic control unit (ECU);
wherein sensor data captured by the sensor is transferred to the ECU;
wherein the ECU comprises electronic circuitry and associated software, and wherein the electronic circuitry of the ECU comprises a processor operable to process sensor data captured by the sensor and transferred to the ECU;
wherein the vehicular driving assist system is operable to at least partially control the equipped vehicle as the equipped vehicle moves in a direction of travel on a road;
wherein, as the equipped vehicle moves in the direction of travel on the road, and at least in part via processing sensor data captured by the sensor and transferred to the ECU, the vehicular driving assist system determines a following vehicle at least rearward of the equipped vehicle and travelling in the direction of travel on the road;
wherein, as the equipped vehicle moves in the direction of travel on the road, the vehicular driving assist system determines (i) a road condition at least forward of the equipped vehicle and (ii) a potential forward braking event of the equipped vehicle relative to the road condition;
wherein, with the determined following vehicle at least rearward of the equipped vehicle, and based on determination of the potential forward braking event, the vehicular driving assist system adjusts control of the equipped vehicle to commence reducing the speed of the equipped vehicle at a first distance relative to the determined road condition; and
wherein, with no following vehicle determined to be at least rearward of the equipped vehicle, and based on determination of the potential forward braking event, the vehicular driving assist system adjusts control of the equipped vehicle to commence reducing the speed of the equipped vehicle at a second distance relative to the determined road condition, and wherein the first distance is greater than the second distance.

2. The vehicular driving assist system of claim 1, wherein responsive to determining the following vehicle at least rearward of the equipped vehicle, and based at least in part on determination of the potential forward braking event, the vehicular driving assist system determines a rearward collision risk between the equipped vehicle and the determined following vehicle.

3. The vehicular driving assist system of claim 2, wherein the vehicular driving assist system adjusts control of the equipped vehicle to commence reducing the speed of the equipped vehicle at the first distance to reduce the determined rearward collision risk.

4. The vehicular driving assist system of claim 2, wherein determination of the rearward collision risk is at least partially based on at least one selected from the group consisting of (i) a determined speed of the determined following vehicle, (ii) a determined distance between the equipped vehicle and the determined following vehicle and (iii) a determined path of travel of the determined following vehicle.

5. The vehicular driving assist system of claim 2, wherein determination of the rearward collision risk is at least partially based on at least one selected from the group consisting of (i) a speed of the equipped vehicle, (ii) a determined distance between the equipped vehicle and the determined road condition and (iii) a determined stopping distance of the equipped vehicle.

6. The vehicular driving assist system of claim 2, wherein, based on determination of the potential forward braking event, and based on the determined rearward collision risk being greater than a threshold level, the vehicular driving assist system adjusts control of the equipped vehicle to commence reducing the speed of the equipped vehicle at the first distance relative to the determined road condition.

7. The vehicular driving assist system of claim 2, wherein, based on determination of the potential forward braking event, and based on a determined rearward collision risk being less than a threshold level, the vehicular driving assist system adjusts control of the equipped vehicle to commence reducing the speed of the equipped vehicle at the second distance relative to the determined road condition.

8. The vehicular driving assist system of claim 1, wherein the sensor comprises a radar sensor.

9. The vehicular driving assist system of claim 1, wherein the sensor comprises a camera.

10. The vehicular driving assist system of claim 1, wherein the determined road condition comprises an object ahead of the equipped vehicle.

11. The vehicular driving assist system of claim 1, wherein the determined road condition comprises a leading vehicle ahead of the equipped vehicle.

12. The vehicular driving assist system of claim 1, wherein the determined road condition comprises an intersection of the road ahead of the equipped vehicle.

13. The vehicular driving assist system of claim 1, wherein the determined road condition comprises a curved portion of the road ahead of the equipped vehicle.

14. The vehicular driving assist system of claim 1, wherein the determined road condition comprises a reduced speed zone of the road ahead of the equipped vehicle.

15. The vehicular driving assist system of claim 1, wherein, based on determination of a distracted driving behavior by a driver monitoring system (DMS) of the equipped vehicle, the vehicular driving assist system generates an alert.

16. The vehicular driving assist system of claim 15, wherein determination of the distracted driving behavior is based on a determined identity of a driver of the equipped vehicle.

17. The vehicular driving assist system of claim 16, wherein the DMS determines the distracted driving behavior based on matching a determined behavior of the driver to a prohibited behavior associated with the determined identity of the driver.

18. The vehicular driving assist system of claim 17, wherein the prohibited behavior is customizable by an owner of the equipped vehicle.

19. The vehicular driving assist system of claim 15, wherein the vehicular driving assist system generates the alert to a driver of the equipped vehicle.

20. The vehicular driving assist system of claim 15, wherein the vehicular driving assist system generates the alert to a user device remote from the equipped vehicle.

21. The vehicular driving assist system of claim 1, wherein the vehicular driving assist system determines (i) the road condition at least forward of the equipped vehicle and (ii) the potential forward braking event of the equipped vehicle relative to the road condition based at least in part on processing of sensor data captured by a forward-sensing sensor of the equipped vehicle.

22. The vehicular driving assist system of claim 21, wherein the forward-sensing sensor comprises at least one selected from the group consisting of (i) a forward-sensing radar sensor and a forward-viewing camera.

23. A vehicular driving assist system, the vehicular driving assist system comprising:
a rearward-sensing sensor disposed at a vehicle equipped with the vehicular driving assist system, wherein the rearward-sensing sensor senses a rearward region exterior of the equipped vehicle and at least rearward of the equipped vehicle, and wherein the rearward-sensing sensor is operable to capture sensor data;
a forward-sensing sensor disposed at the vehicle, wherein the forward-sensing sensor senses a forward region exterior of the equipped vehicle and at least forward of the equipped vehicle, and wherein the forward-sensing sensor is operable to capture sensor data;
an electronic control unit (ECU);
wherein sensor data captured by the rearward-sensing sensor and sensor data captured by the forward-sensing sensor is transferred to the ECU;
wherein the ECU comprises electronic circuitry and associated software, and wherein the electronic circuitry of the ECU comprises a processor operable to process sensor data captured by the rearward-sensing sensor and transferred to the ECU and sensor data captured by the forward-sensing sensor and transferred to the ECU;
wherein the vehicular driving assist system is operable to at least partially control the equipped vehicle as the equipped vehicle moves in a direction of travel on a road;
wherein, as the equipped vehicle moves in the direction of travel on the road, and at least in part via processing sensor data captured by the rearward-sensing sensor and transferred to the ECU, the vehicular driving assist system determines a following vehicle at least rearward of the equipped vehicle and travelling in the direction of travel on the road;
wherein, as the equipped vehicle moves in the direction of travel on the road, and at least in part via processing sensor data captured by the forward-sensing sensor and transferred to the ECU, the vehicular driving assist system determines (i) a road condition at least forward of the equipped vehicle and (ii) a potential forward braking event of the equipped vehicle relative to the road condition;
wherein, with the determined following vehicle at least rearward of the equipped vehicle, and based on determination of the potential forward braking event, the vehicular driving assist system adjusts control of the equipped vehicle to commence reducing the speed of the equipped vehicle at a first distance relative to the determined road condition;
wherein, with no following vehicle determined to be at least rearward of the equipped vehicle, and based on determination of the potential forward braking event, the vehicular driving assist system adjusts control of the equipped vehicle to commence reducing the speed of the equipped vehicle at a second distance relative to the determined road condition, and wherein the first distance is greater than the second distance; and
wherein responsive to determining the following vehicle at least rearward of the equipped vehicle, and based at least in part on determination of the potential forward braking event, the vehicular driving assist system determines a rearward collision risk between the equipped vehicle and the determined following vehicle, and wherein the vehicular driving assist system adjusts control of the equipped vehicle to commence reducing the speed of the equipped vehicle at the first distance to reduce the determined rearward collision risk.

24. The vehicular driving assist system of claim 23, wherein, based on determination of the potential forward braking event, and based on the determined rearward collision risk being greater than a threshold level, the vehicular driving assist system adjusts control of the equipped vehicle to commence reducing the speed of the equipped vehicle at the first distance relative to the determined road condition.

25. The vehicular driving assist system of claim 23, wherein, based on determination of the potential forward braking event, and based on a determined rearward collision risk being less than a threshold level, the vehicular driving assist system adjusts control of the equipped vehicle to commence reducing the speed of the equipped vehicle at the second distance relative to the determined road condition.

26. The vehicular driving assist system of claim 23, wherein the rearward-sensing sensor comprises at least one selected from the group consisting of (i) a radar sensor and (ii) a camera, and wherein the forward-sensing sensor comprises at least one selected from the group consisting of (a) a radar sensor and (b) a camera.

27. A vehicular driving assist system, the vehicular driving assist system comprising:
a sensor disposed at a vehicle equipped with the vehicular driving assist system, wherein the sensor senses a region exterior of the equipped vehicle and at least rearward of the equipped vehicle, and wherein the sensor is operable to capture sensor data;
an electronic control unit (ECU);
wherein sensor data captured by the sensor is transferred to the ECU;
wherein the ECU comprises electronic circuitry and associated software, and wherein the electronic circuitry of the ECU comprises a processor operable to process sensor data captured by the sensor and transferred to the ECU;
wherein the vehicular driving assist system is operable to at least partially control the equipped vehicle as the equipped vehicle moves in a direction of travel on a road;
wherein, as the equipped vehicle moves in the direction of travel on the road, and at least in part via processing sensor data captured by the sensor and transferred to the ECU, the vehicular driving assist system determines a following vehicle at least rearward of the equipped vehicle and travelling in the direction of travel on the road;
wherein, as the equipped vehicle moves in the direction of travel on the road, the vehicular driving assist system determines (i) a road condition at least forward of the equipped vehicle and (ii) a potential forward braking event of the equipped vehicle relative to the road condition;
wherein, with the determined following vehicle at least rearward of the equipped vehicle, and based on determination of the potential forward braking event, the vehicular driving assist system adjusts control of the equipped vehicle to commence reducing the speed of the equipped vehicle at a first distance relative to the determined road condition;
wherein, with no following vehicle determined to be at least rearward of the equipped vehicle, and based on determination of the potential forward braking event, the vehicular driving assist system adjusts control of the equipped vehicle to commence reducing the speed of the equipped vehicle at a second distance relative to the determined road condition, and wherein the first distance is greater than the second distance;
wherein responsive to determining the following vehicle at least rearward of the equipped vehicle, and based at least in part on determination of the potential forward braking event, the vehicular driving assist system determines a rearward collision risk between the equipped vehicle and the determined following vehicle, and wherein the vehicular driving assist system adjusts control of the equipped vehicle to commence reducing the speed of the equipped vehicle at the first distance to reduce the determined rearward collision risk; and
wherein determination of the rearward collision risk is at least partially based on at least one selected from the group consisting of (i) a determined speed of the determined following vehicle, (ii) a determined distance between the equipped vehicle and the determined following vehicle and (iii) a determined path of travel of the determined following vehicle.

28. The vehicular driving assist system of claim 27, wherein, based on determination of the potential forward braking event, and based on the determined rearward collision risk being greater than a threshold level, the vehicular driving assist system adjusts control of the equipped vehicle to commence reducing the speed of the equipped vehicle at the first distance relative to the determined road condition.

29. The vehicular driving assist system of claim 27, wherein, based on determination of the potential forward braking event, and based on a determined rearward collision risk being less than a threshold level, the vehicular driving assist system adjusts control of the equipped vehicle to commence reducing the speed of the equipped vehicle at the second distance relative to the determined road condition.

30. The vehicular driving assist system of claim 27, wherein determination of the rearward collision risk is at least partially based on at least one selected from the group consisting of (i) a speed of the equipped vehicle, (ii) a determined distance between the equipped vehicle and the determined road condition and (iii) a determined stopping distance of the equipped vehicle.
